(19) United States
(12) Patent Application Publication
(10) Pub. No.: US 2014/0248791 A1
(43) Pub. Date: Sep. 4, 2014

(54) CABLE CONNECTOR ASSEMBLY

(71) Applicant: Molex Incorporated, Lisle, IL (US)

(72) Inventors: Lin TONG, Dongguan (CN); Xiao-An WANG, Dongguan (CN)

(73) Assignee: Molex Incorporated, Lisle, IL (US)

(21) Appl. No.: 14/193,111

(22) Filed: Feb. 28, 2014

(30) Foreign Application Priority Data
Mar. 1, 2013 (CN) 201320095906.7

(51) Int. Cl. H01R 13/58

(52) U.S. Cl. CPC H01R 13/5845
USPC 439/460

(57) ABSTRACT

A cable connector assembly comprises an electrical connector and a cable connected to a rear side of the electrical connector. The electrical connector comprises an insulative housing and a plurality of conductive terminals fixed thereto. The cable comprises a plurality of wires, a filler among the wires and an insulative covering which covers outer peripheries of the wires and the filler. The wires and the conductive terminals are electrically connected. The cable connector assembly further comprises an inner mold and a casing surrounding an outer periphery of the inner mold. The inner mold is integrally formed at outer peripheries of connections between the conductive terminals and the wires by over-molding. A part of the filler is embedded into the inner mold for stress relief.

### REFERENCE TO RELATED APPLICATIONS

The Present Application claims priority to Chinese Utility Model Patent Application No. 201320095906.7, entitled “Cable Connector Assembly,” and filed 1 Mar. 2013, the content of which is fully incorporated in its entirety herein.

### BACKGROUND OF THE PRESENT DISCLOSURE

The Present Disclosure relates, generally, to a cable connector assembly, and, more particularly, to a cable connector assembly which allows for relief of tensile stress.

Chinese Patent Application No. 200720139591.6, the content of which is fully incorporated herein in its entirety, discloses a cable connector, which comprises an electrical connector and a cable connected to a rear end of the electrical connector. The electrical connector has a plurality of conductive terminals, a shielding shell made from a conductive metal and a clamp device provided at a rear end of the shielding shell. The cable comprises a plurality of wires, a plurality of cable fillers, a metal braided layer and an outer covering. The metal braided layer covers an outer periphery of these wires and cable fillers. The outer covering then covers an outer periphery of the metal braided layer. The wires of the cable are correspondingly electrically connected to conductive terminals of the electrical connector. The cable fillers in the cable and the metal braided layer are folded back onto an outer surface of the outer covering. The clamp device of the electrical connector then tightly clamps the cable. The cable fillers and the metal braided layer which are folded back therein. The existing cable connector is provided with the clamp device at the rear end of the shielding shell to clamp the cable fillers and the cable so as to attain an effect of stress relief, but a configuration of the shielding shell, formed by stamping a metal material, is complex and has a high cost. In another aspect, during the process of folding back the cable fillers and the metal braided layer of such the cable connector, the cable fillers are easily to cover the metal braided layer, meaning that the metal braided layer can not establish an electrical connection with the clamp device, thereby resulting a poor grounding. Thus, it is necessary to improve the existing cable connector assembly.

### SUMMARY OF THE PRESENT DISCLOSURE

The technology problem to be resolved by the Present Disclosure is to overcome the deficiencies of the existing technology, and to provide a cable connector assembly which has a simple configuration, a low cost and can allow a tensile stress to be better relieved.

In view of the above issues, the Present Disclosure provides a cable connector assembly, which comprises an electrical connector and a cable connected to a rear side of the electrical connector. The electrical connector comprises an insulative housing and a plurality of conductive terminals fixed to the insulative housing. The cable comprises a plurality of wires, at least a cable filler filled among these wires and an insulative covering which covers outer peripheries of the wires and the cable filler. The wires and the conductive terminals of the electrical connector are electrically connected together. The cable connector assembly further comprises an inner mold and a casing surrounding an outer periphery of the inner mold. The inner mold is integrally formed at outer peripheries of connections between the conductive terminals and the wires by over-molding and a part of the cable filler is embedded into the inner mold for stress relief.

In an embodiment, the electrical connector further comprises a metal shell provided at an outer periphery of the insulative housing. The cable further comprises a shielding layer surrounding the peripheries of these wires and the cable filler. The insulative covering further covers an outer periphery of the shielding layer. The cable connector assembly further comprises a metal foil covering the outer periphery of the inner mold. The metal foil, the metal shell and the shielding layer are electrically connected together.

In an embodiment, the shielding layer is a metal braided layer, the shielding layer, the metal foil and the metal shell are electrically connected together by soldering. In an embodiment, the metal shell has a body which is hollow and has a cylinder shape and a flange extending outwardly from the body. The body of the metal shell covers the insulative housing therein. Two sides of the flange each are formed with an assembly hole. The two assembly holes each are assembled with a fixing member therein. In an embodiment, the casing is formed with two mounting holes corresponding to the two assembly holes. The two fixing members are two fixing bolts, which are respectively provided through the two mounting holes of the casing and the two assembly holes of the metal shell. In an embodiment, the casing is integrally formed at the outer periphery of the metal foil by over-molding using a plastic material, two sides of the casing each are respectively formed with an uneven grasping portion.

In an embodiment, the casing is integrally formed by over-molding using a plastic material. A rear end of the casing covers an outer periphery of the cable and is formed with a stress relief structure. In an embodiment, the electrical connector further comprises a metal shell provided at an outer periphery of the insulative housing. A front end of the casing covers the metal shell of the electrical connector. In an embodiment, the inner mold is integrally formed by over-molding using a PE plastic material. The casing is integrally formed by over-molding using a PVC plastic material. In an embodiment, the cable filler is consisted of fiber, nylon wire or cotton rope.

Compared with the existing technology, the cable connector assembly of the Present Disclosure relieves the tensile stress by embedding the cable filler of the cable inside the inner mold by integral over-molding, is simple in the configuration, has a low cost and can allow the tensile stress to be better relieved.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a cable connector assembly of the Present Disclosure;

FIG. 2 is another perspective view of the cable connector assembly of FIG. 1;

FIG. 3 is an exploded perspective view of the cable connector of FIG. 1;

FIG. 4 is another exploded perspective view of the cable connector assembly of FIG. 3;

FIG. 5 is another exploded perspective view of the cable connector assembly of FIG. 3; and

FIG. 6 is another exploded perspective view of the cable connector assembly of FIG. 3.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

In the embodiments illustrated in the Figures, representations of directions such as up, down, left, right, front, rear and the like, used for explaining the structure and movement of the various elements of the Present Disclosure, are not absolute, but relative. These representations are appropriate when the elements are in the position shown in the Figures. If the description of the position of the elements changes, however, it is assumed that these representations are to be changed accordingly.

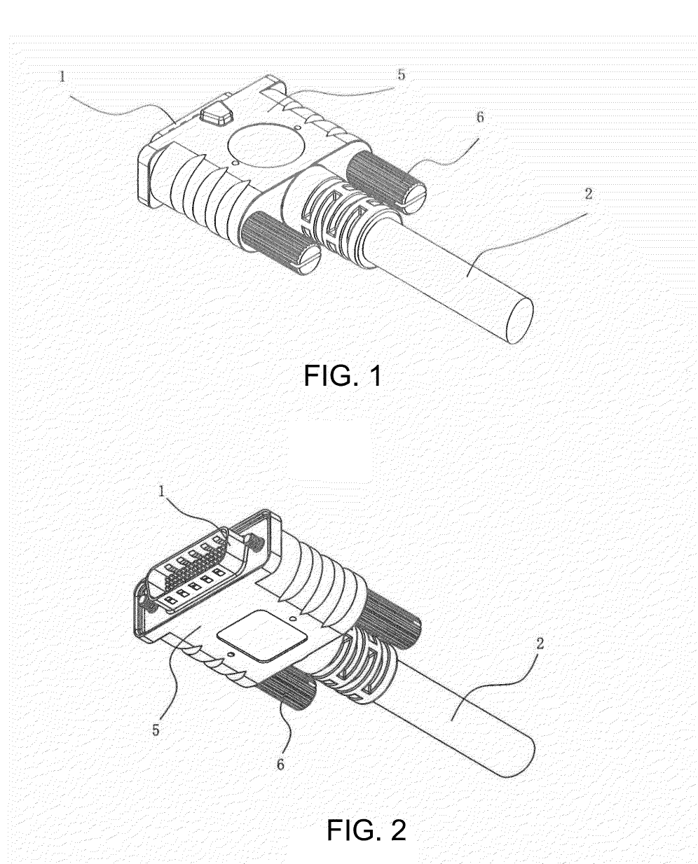

Referring to FIGS. 1-6, the Present Disclosure provides a cable connector assembly, which comprises an electrical connector 1, a cable 2 connected to a rear side of the electrical connector 1, an inner mold 3 formed at an outer periphery of a connection between the electrical connector 1 and the cable 2 by over-molding, a metal foil 4 (such as a copper foil) covering an outer periphery of the inner mold 3 by over-molding, a casing 5 further formed at an outer periphery of the metal foil 4 by over-molding, and two fixing members 6 (two fixing bolts in the embodiment) respectively assembled at two sides of the electrical connector 1.

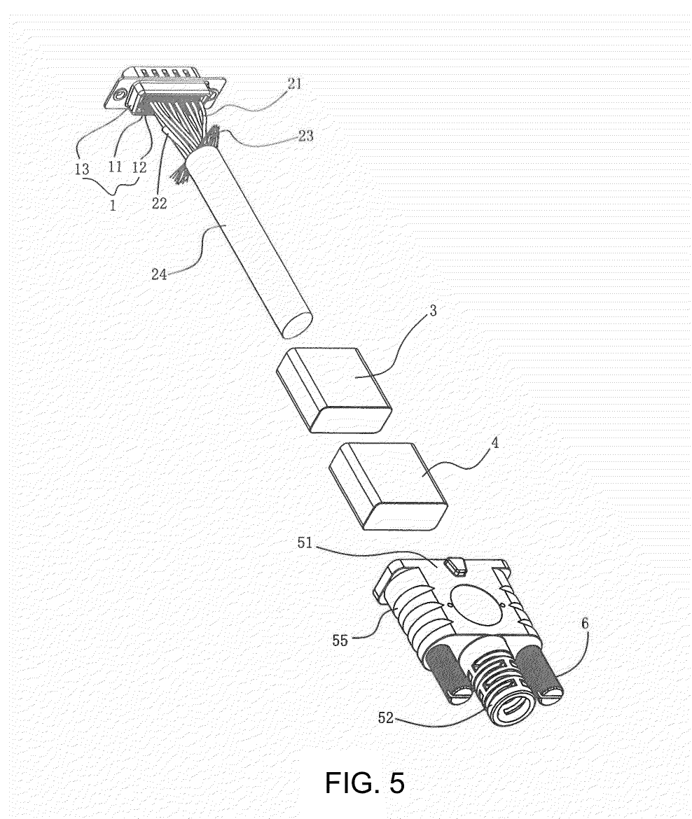

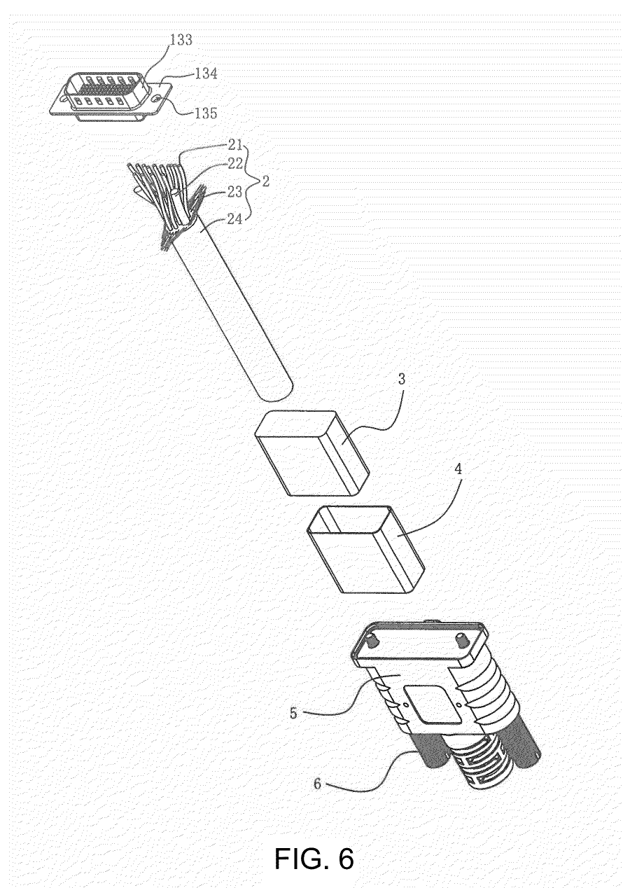

Referring to FIGS. 5-6, the electrical connector 1 comprises a metal shell 13, an insulative housing 11 fixedly received inside the metal shell 13 and a plurality of conductive terminals 12 inserted into and fixed to the insulative housing 11. The insulative housing 11 is integrally formed by inject-molding using a plastic material. The each conductive terminal 12 is correspondingly inserted into a corresponding receiving groove of the insulative housing 11, a soldering portion of the each conductive terminal 12 extends rearwardly out of a rear side of the insulative housing 11. The metal shell 13 has a body 133, which is opened in a front-rear penetrating manner and has a hollow cylinder shape, and a flange 134 extending outwardly from a middle part of the body 133, two sides of the flange 134 in a horizontal direction each are provided with an assembly hole 135. The two assembly holes 135 each are provided through a fixing member 6 therein to allow the cable connector assembly to be securely fixed to another mating electrical connector (not shown) so as to avoid an improper disengagement. The body 133 of the metal shell 13 completely covers side edges of the insulative housing 11 therein, thereby reaching a better shielding effect.

Referring to FIG. 6, the cable 2 comprises a plurality of wires 21 for transmitting a signal, a plurality of cable fillers 22 filled among these wires 21, a shielding layer 23 (e.g., a metal braided layer braided by a plurality of bare metal conductors) surrounding outer peripheries of the wires 21 and the cable fillers 22 and an insulative covering 24 further covering an outer periphery of the shielding layer 23. Specifically, the each wire 21 comprises an insulative sleeve and a metal core conductor provided through inside of the insulative sleeve (not specifically shown). One end of each of these wires 21 is electrically connected (in this embodiment is directly soldered, and in other embodiments can also be interconnected via a circuit board) to a soldering end of each of these conductive terminals 12, the other end of each of these wires 21 is electrically connected to an electrical connector (not shown) at the other end of the cable 2. These cable fillers 22 are consisted of flexible insulative wires (e.g., fiber, nylon wire, cotton rope and the like), these cable fillers 22 are correspondingly filled in gaps of these wires 21 to maintain a regular circle appearance and a stronger tensile strength of the cable 2.

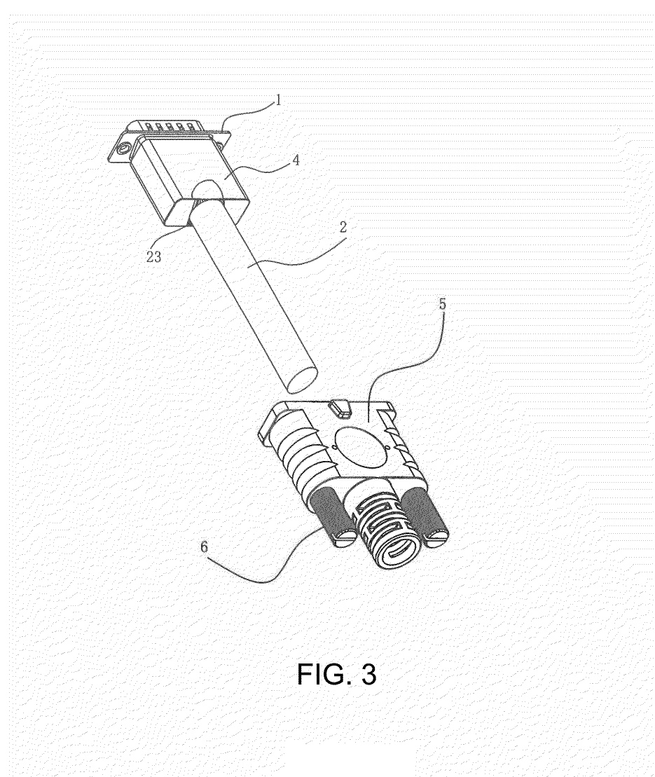

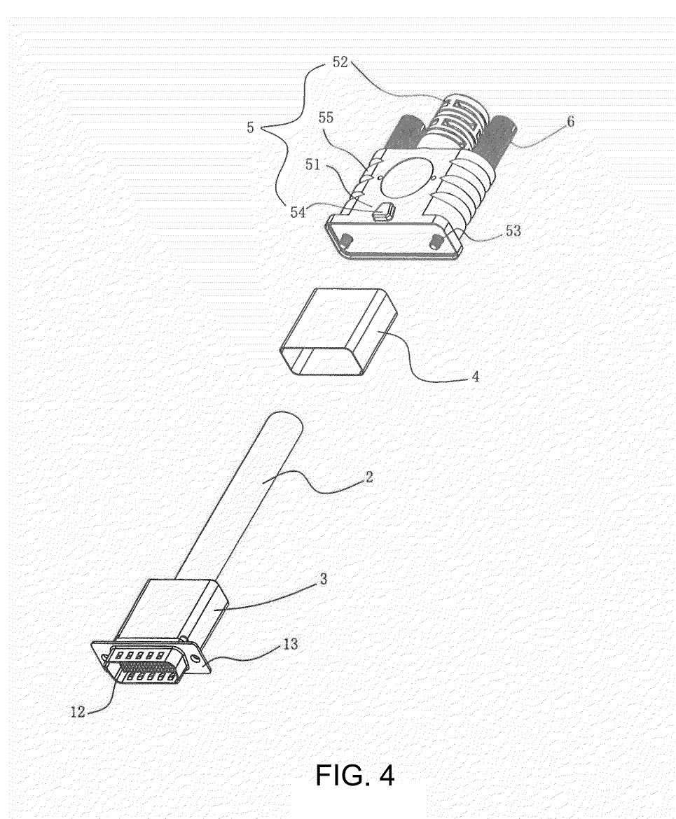

Referring to FIGS. 3-4, the inner mold 3 is formed at the outer periphery of the connection between the electrical connector 1 and the cable 2 by over-molding using a PE (Poly Ethylene) plastic material. Over-molding using the PE plastic material can have a lower molding temperature and pressure, which can prevent the connection from being damaged during the molding process of the inner mold 3, in addition can also function to strengthen the connection. It should be noted that distal ends of the cable fillers 22 of the cable 2 are together embedded inside the inner mold 3, and a front end of the inner mold 3 covers a rear end of the metal shell 13, which can better relieve a tensile stress of the cable 2 to the metal shell 13, so as to make the cable 2 not easily swayed to result in connections of the wires 21 and the conductive terminals 12 to be broken when subjected to a force, and facilitates improvement of flexing resistance of the cable 2.

Referring to FIGS. 3-4, specifically, in the embodiment, the metal foil 4 is a layer of copper foil paper covering the outer periphery of the inner mold 3, the metal foil 4, the metal shell 13 and the shielding layer 23 are electrically connected together, which can function as a whole electromagnetic shielding. Specifically, the shielding layer 23 is soldered to an outer periphery of a rear end of the metal foil 4 by soldering tin paste; and a front end of the metal foil 4 and the body 133 of the metal shell 13 are partially lapped together (may also be soldered together), the shielding configuration in such a way has advantages of easy fabrication and low-cost; and the shielding layer 23 of the cable 2 and the cable fillers 22 are isolated from the metal foil 4 by the inner mold 3, which facilitates the shielding layer 23 to be better electrically connected with the metal foil 4 and thus to achieve a better grounding effect.

The casing 5 is further formed at the outer periphery of the metal foil 4 by over-molding using a PVC (Polyvinyl Chloride) plastic material, the PVC plastic material has a stronger mechanical property and physical property, which can improve a structural strength and the durability of the casing 5. A front end 51 of the casing 5 covers the metal shell 13 of the electrical connector 1. Specifically, the front end 51 of the casing 5 covers a side surface and a rear surface of the flange 134 of the metal shell 13 of the electrical connector 1. A rear end of the casing 5 covers the outer periphery of the cable 2 and is formed with a stress relief structure 52 extending rearwardly. When the cable 2 is subjected to a pulling or a swaying, a tensile stress can be transferred to the front end 51 of the casing 5 by the stress relief structure 52 at the rear end of the casing 5, and further transferred to the metal shell 13 of the electrical connector 1, thereby making the connections between the wires 21 and the conductive terminals 12 not easily affected by the tensile stress so as to function as protection. Two sides of the casing 5 are respectively provided with two mounting holes 53 which penetrate in a front-rear direction and correspond to the assembly holes 135 of the metal shell 1, for the two fixing members 6 being respectively provided through them. Moreover, an upper surface of the front end 51 of the casing 5 is protruded with a protruding portion 54, which facilitates the cable connector assembly to accurately mate with another mating electrical connector (not shown). Two sides of the casing 5 each are formed with an uneven grasping portion 55, which facilitates a user to assuredly grasp the cable connector assembly to perform a mating operation. It should be noted that, although the casing 5 in the embodiment covers the inner mold 3 and the like therein by integral over-molding, but in other embodiments, the casing 5 may also be a configuration consisted of two pieces which are separated up-down, then are assembled together with a latch element so as to surround the inner mold 3 and the like therein.

The fabricating and assembly process of the cable connector assembly of the Present Disclosure substantially comprises the following steps: Firstly, assembling the metal shell 13, the insulative housing 11 and the conductive terminals 12 to form an electrical connector 1; Second, correspondingly soldering the wires 21 of the cable 2 to the soldering portions of the conductive terminals 12 of the electrical connector 1; then forming the inner mold 3 by over-molding for the first time; Third, making the metal foil 4 cover the outer periphery of the inner mold 3, and soldering the shielding layer 23 of the cable 2 and the metal foil 4 together by the tin paste; And fourth, forming the casing 5 by over-molding for the second time, and assembling the two fixing members 6 onto the casing 5.

Compared with the existing technology, a main part of the tensile stress in the cable 2 of the cable connector assembly of the Present Disclosure is transferred to the metal shell 13 of the electrical connector 1 via the stress relief structure 52 of the casing 5. A remaining part of the tensile stress is transferred to the inner mold 3 via the cable fillers 22 embedded inside the inner mold 3 and then further transferred to the metal shell 13, thereby making the tensile stress completely relieved. In this way, the connections of the wires 21 and the conductive terminals 12 by soldering are not easily affected by the tensile stress to occur an accidental damage, and the stress relief structure 52, which is integrally formed by over-molding to make the cable fillers 22 directly embedded in the inner mold 3 to relieve the remaining part of the tensile stress, has the advantages of a simple configuration and a low-cost. Moreover, it is worth mentioning that, the stress relief structure 52 can be implemented in various forms, and is not limit to the form of the embodiment that the stress relief structure 52, together with the casing 5, is integrally formed at the outer surface of the cable 2 by over-molding. In other embodiments which is not shown, the stress relieving structure 52 may also take the form disclosed in the aforementioned Chinese Patent Application; that is, the clamp device stamped and clamping the outer periphery of the cable 2.

It is noted that, in other embodiments, if the cable connector assembly is not so strict about the electromagnetic shielding, the metal shell 13 of the electrical connector 1, the shielding layer 23 of the cable 2 and the metal foil 4 may be partially or even totally omitted. In this manner, the casing 5 may be directly formed at the outer periphery of the inner mold 3 by over-molding, and the front end 51 of the casing 51 is changed to directly cover the insulative housing 11.

While a preferred embodiment of the Present Disclosure is shown and described, it is envisioned that those skilled in the art may devise various modifications without departing from the spirit and scope of the foregoing Description and the appended Claims.

What is claimed is:

1. A cable connector assembly, the cable connector assembly comprising
an electrical connector, the electrical connector including an insulative housing and a plurality of conductive terminals fixed to the housing;
a cable connected to a rear side of the electrical connector, the cable including a plurality of wires, a cable filler being filled among the wires and an insulative covering which covers outer peripheries of the wires and the cable filler, the wires and the conductive terminals of the electrical connector being electrically connected together;
an inner mold, the inner mold being integrally formed at outer peripheries of connections between the conductive terminals and the wires, a portion of the cable filler being embedded into the inner mold for stress relief; and
a casing surrounding an outer periphery of the inner mold.

2. The cable connector assembly of claim 1, wherein the electrical connector further includes a metal shell provided at an outer periphery of the insulative housing.

3. The cable connector assembly of claim 2, wherein the cable further includes a shielding layer surrounding the peripheries of the wires and the cable filler.

4. The cable connector assembly of claim 3, wherein the insulative covering further covers an outer periphery of the shielding layer.

5. The cable connector assembly of claim 4, further comprising a metal foil covering the outer periphery of the inner mold.

6. The cable connector assembly of claim 5, wherein the metal foil, the metal shell and the shielding layer are electrically connected together.

7. The cable connector assembly claim 6, wherein the shielding layer is a metal braided layer.

8. The cable connector assembly of claim 7, wherein the shielding layer, the metal foil and the metal shell are electrically connected together by soldering.

9. The cable connector assembly of claim 6, wherein the metal shell has a hollow body, and has a cylinder shape and a flange extending outwardly therefrom.

10. The cable connector assembly of claim 9, wherein the body covers the insulative housing therein.

11. The cable connector assembly of claim 10, wherein each side of the flange is formed with an assembly hole.

12. The cable connector assembly of claim 11, wherein each assembly hole is received with a fixing member therein.

13. The cable connector assembly of claim 12, wherein the casing is formed with two mounting holes corresponding to the two assembly holes.

14. The cable connector assembly of claim 13, wherein the two fixing members are two fixing bolts.

15. The cable connector assembly of claim 14, wherein the two fixing members are respectively provided through the two mounting holes of the casing and the two assembly holes of the metal shell.

16. The cable connector assembly of claim 6, wherein the casing is integrally formed at the outer periphery of the metal foil by over-molding using a plastic material.

17. The cable connector assembly of claim 16, wherein two sides of the casing are respectively formed with an uneven grasping portion.

18. The cable connector assembly of claim 17, wherein a front end of the casing covers the metal shell of the electrical connector.

19. The cable connector assembly of claim 1, wherein the casing is integrally formed by over-molding using a plastic material, a rear end of the casing covering an outer periphery of the cable and formed with a stress relief structure.

20. The cable connector assembly of claim 1, wherein the inner mold is integrally formed by over-molding using a PE plastic material, the casing integrally formed by over-molding using a PVC plastic material.
